(19) United States
(12) Patent Application Publication
(10) Pub. No.: US 2026/0192763 A1
(43) Pub. Date: Jul. 9, 2026

(54) ON-BOARD CONTROL APPARATUS, OPERATION CONTROL METHOD, AND COMMUNICATION SYSTEM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Darmawan GO, Yokkaichi-shi, Mie (JP); Kazuki KITAGAWA, Yokkaichi-shi, Mie (JP); Hirofumi URAYAMA, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/132,896

(22) PCT Filed: Nov. 17, 2023
(86) PCT No.: PCT/JP2023/041504

§ 371 Date: May 27, 2025

(30) Foreign Application Priority Data
Nov. 28, 2022 (JP) 2022-189047

(51) Int. Cl. B60R 16/023

(52) U.S. Cl. CPC B60R 16/0231

(57) ABSTRACT

An on-board control apparatus for use in an on-board network including a plurality of on-board apparatuses, the on-board control apparatus including: a detecting unit that detects a type of service to be executed in the on-board network; and a controlling unit that, in a state in which a plurality of service-associated apparatuses, which are predetermined ones of the on-board apparatuses that correspond to the type of service detected by the detecting unit, are in operation, selects a subset of the service-associated apparatuses and performs stop control for stopping the operation of the selected service-associated apparatuses.

### CROSS-REFERENCE TO RELATED APPLICATIONS

This application is the U.S. national stage of PCT/JP2023/041504 filed on Nov. 17, 2023, which claims priority of Japanese Patent Application No. JP 2022-189047 filed on Nov. 28, 2022, the contents of which are incorporated herein.

### TECHNICAL FIELD

The present disclosure relates to an on-board control apparatus, an operation control method, and a communication system.

### BACKGROUND

JP 2021-182679A discloses the following technique. That is, a communication system disclosed in JP 2021-182679A is a communication system including a network (1), and a plurality of control apparatuses (10, 20, 30, 40, and 50) that are connected to the network and that can mutually communicate via the network, wherein: the plurality of control apparatuses at least include first and second control apparatuses; the first and second control apparatuses can transmit a network management frame for managing communication in the network; upon executing communication-required control, in which data communication using a data frame needs to be performed with another control apparatus, the first and second control apparatuses create the network management frame including group information indicating one or more groups of control apparatuses between which communication of the data frame is to be performed, and transmits the network management frame to the plurality of control apparatuses via the network; the first and second control apparatuses have, in association with the group information, load information for detecting the communication load in the network in a case in which communication of the data frame is performed by the control apparatuses included in the groups indicated by the group information; and, in a case in which the other of the first and second control apparatuses is to start communication-required control, in which communication of the data frame with another control apparatus needs to be performed, after receiving the network management frame including the group information from one of the first and second control apparatuses, the other of the first and second control apparatuses detects the current communication load in the network based on the load information and the group information included in the received network management frame, determines, in consideration of the current communication load, one or more groups of control apparatuses between which communication of the data frame is to be performed so that the communication load in the network would not exceed a communication load threshold, and controls creation of the network management frame so that communication by the determined groups is performed.

For example, a plurality of services are executed in an on-board network. The on-board apparatuses to be in operation during execution of each service in the on-board network are determined in advance based on the model of the vehicle in which the on-board network is installed, the configuration of the on-board network, or the like.

However, depending on the user of the vehicle, it may be unnecessary to keep all predetermined on-board apparatuses corresponding to a given service in operation during execution of the service. In such a case, power consumption by the on-board apparatuses that do not need to be in operation would be wasted.

The present disclosure has been made to solve the above-described problem, and an aim thereof is to provide an on-board control apparatus, an operation control method, and a communication system that make it possible to improve a power-saving function of an on-board network.

### SUMMARY

Conventionally, techniques have been proposed for performing control in accordance with communication load in an on-board network including a plurality of on-board apparatuses.

An on-board control apparatus according to the present disclosure is an on-board control apparatus for use in an on-board network including a plurality of on-board apparatuses, the on-board control apparatus including: a detecting unit that detects a type of service to be executed in the on-board network; and a controlling unit that, in a state in which a plurality of service-associated apparatuses, which are predetermined ones of the on-board apparatuses that correspond to the type of service detected by the detecting unit, are in operation, selects a subset of the service-associated apparatuses and performs stop control for stopping the operation of the selected service-associated apparatuses.

One aspect of the present disclosure can be implemented not only as an on-board control apparatus including such characteristic processing units but also as a program for causing a computer to execute steps corresponding to such characteristic processes. Furthermore, one aspect of the present disclosure can be implemented as a semiconductor integrated circuit that realizes a part or the entirety of the on-board control apparatus.

### Advantageous Effects

According to the present disclosure, a power-saving function of an on-board network can be improved.

### BRIEF DESCRIPTION OF DRAWINGS

FIG. 1 is a diagram illustrating a configuration of an on-board system according to a first embodiment of the present disclosure.

FIG. 2 is a diagram illustrating a configuration of an integrated ECU according to the first embodiment of the present disclosure.

FIG. 3 is a diagram illustrating an example of management information stored in the integrated ECU according to the first embodiment of the present disclosure.

FIG. 4 is a diagram illustrating an example of service information created by the integrated ECU according to the first embodiment of the present disclosure.

FIG. 5 is a diagram illustrating an example of the management information after an update process by the integrated ECU according to the first embodiment of the present disclosure.

FIG. 6 is a diagram illustrating a specific example of the service information created by the integrated ECU according to the first embodiment of the present disclosure.

FIG. 7 is a diagram illustrating a specific example of the service information created by the integrated ECU according to the first embodiment of the present disclosure.

FIG. 8 is a diagram illustrating a specific example of the service information created by the integrated ECU according to the first embodiment of the present disclosure.

FIG. 9 is a flowchart defining an operation procedure when the integrated ECU according to the first embodiment of the present disclosure controls service-associated apparatuses.

FIG. 10 is a diagram illustrating a configuration of a communication system according to a second embodiment of the present disclosure.

FIG. 11 is a diagram illustrating a configuration of an integrated ECU according to the second embodiment of the present disclosure.

FIG. 12 is a diagram illustrating a configuration of a management apparatus according to the second embodiment of the present disclosure.

FIG. 13 is a flowchart defining an operation procedure when the integrated ECU according to the second embodiment of the present disclosure controls service-associated apparatuses.

FIG. 14 is a diagram illustrating an example of a sequence of operation change control in the communication system according to the second embodiment of the present disclosure.

### DETAILED DESCRIPTION OF PREFERRED EMBODIMENTS

First, the contents of embodiments of the present disclosure will be listed and described.

In a first aspect, an on-board control apparatus according to an embodiment of the present disclosure is an on-board control apparatus for use in an on-board network including a plurality of on-board apparatuses, the on-board control apparatus including: a detecting unit that detects a type of service to be executed in the on-board network; and a controlling unit that, in a state in which a plurality of service-associated apparatuses, which are predetermined ones of the on-board apparatuses that correspond to the type of service detected by the detecting unit, are in operation, selects a subset of the service-associated apparatuses and performs stop control for stopping the operation of the selected service-associated apparatuses.

By adopting a configuration in which the operation of selected ones of the plurality of service-associated apparatuses is stopped in such a manner, wasteful power consumption can be suppressed because the operation of ones of the plurality of service-associated apparatuses that do not need to be in operation can be stopped, for example. Accordingly a power-saving function of the on-board network can be improved.

In a second aspect according to the first aspect, the on-board control apparatus may further include an acquiring unit that acquires service information that indicates, for the individual service, one or more of the service-associated apparatuses to be in operation during execution of the service and one or more of the service-associated apparatuses operation of which is to be stopped during execution of the service, and the controlling unit may select the service-associated apparatuses to be subjected to the stop control based on the service information acquired by the acquiring unit.

By adopting such a configuration, service-associated apparatuses to be subjected to the stop control and service-associated apparatuses for which the stop control is to be disabled can be easily selected using the service information.

In a third aspect according to the second aspect, the controlling unit may perform control for activating the plurality of service-associated apparatuses corresponding to the type of service once the type of service is detected by the detecting unit, the on-board control apparatus may further include a monitoring unit that monitors the operation of the plurality of service-associated apparatuses, and the acquiring unit may acquire the service information created based on a monitoring result obtained by the monitoring unit.

By adopting such a configuration, appropriate service-associated apparatuses to be subjected to the stop control can be selected in accordance with the operation statuses of the service-associated apparatuses. Furthermore, service-associated apparatuses for which the stop control is to be disabled can be appropriately selected in accordance with the above-described statuses.

In a fourth aspect according to any one of the first to the third aspects, the plurality of service-associated apparatuses may include ones of the service-associated apparatuses provided in correspondence with seats in a vehicle in which the on-board network is installed.

By adopting such a configuration, during execution of a service provided in seats of the vehicle for example, wasteful power consumption during the execution of the service can be suppressed because the operation of service-associated apparatuses corresponding to seats in which the service does not need to be provided can be stopped.

In a fifth aspect according to any one of the first to the third aspects, the plurality of service-associated apparatuses may include ones of the service-associated apparatuses provided in correspondence with installation positions of on-board devices in a vehicle in which the on-board network is installed.

By adopting such a configuration, during execution of a service in which data transmitted from on-board devices is used for example, wasteful power consumption during the execution of the service can be suppressed because the operation of service-associated apparatuses corresponding to installation positions of on-board devices that do not need to transmit data can be stopped.

In a sixth aspect according to any one of the first to the third aspects, the plurality of service-associated apparatuses may include ones of the service-associated apparatuses provided in correspondence with doors of a vehicle in which the on-board network is installed.

By adopting such a configuration, during execution of a service relating to the opening/closing of doors for boarding/alighting for example, wasteful power consumption during the execution of the service can be suppressed because the operation of service-associated apparatuses corresponding to doors that do not need to be opened/closed can be stopped.

In a seventh aspect, an operation control method according to an embodiment of the present disclosure is a method for controlling operations in an on-board control apparatus that is for use in an on-board network including a plurality of on-board apparatuses, the operation control method including: a step of detecting a type of service to be executed in the on-board network; and a step of, in a state in which a plurality of service-associated apparatuses, which are predetermined ones of the on-board apparatuses that correspond to the detected type of service, are in operation, selecting a subset of the service-associated apparatuses and performing stop control for stopping the operation of the selected service-associated apparatuses.

By adopting a configuration in which the operation of selected ones of the plurality of service-associated apparatuses is stopped in such a manner, wasteful power consumption can be suppressed because the operation of ones of the plurality of service-associated apparatuses that do not need to be in operation can be stopped, for example. Accordingly a power-saving function of the on-board network can be improved.

In an eighth aspect, a communication system according to an embodiment of the present disclosure includes: an on-board control apparatus; and a management apparatus, wherein the on-board control apparatus transmits, to the management apparatus, monitoring information indicating a monitoring result relating to operation of a plurality of service-associated apparatuses, which are predetermined ones of a plurality of on-board apparatuses included in an on-board network that correspond to a type of service executed in the on-board network, and the management apparatus receives the monitoring information from the on-board control apparatus, and transmits, to the on-board control apparatus, service information indicating one or more of the service-associated apparatuses to be in operation during execution of the service and one or more of the service-associated apparatuses operation of which is to be stopped during execution of the service.

By adopting a configuration in which the on-board control apparatus transmits, to the management apparatus, monitoring information relating to the operation of the plurality of service-associated apparatuses, and the management apparatus receives the monitoring information and transmits service information to the on-board control apparatus, wasteful power consumption can be suppressed because the operation of ones of the plurality of service-associated apparatuses that do not need to be in operation can be stopped by the on-board control apparatus, for example. Accordingly a power-saving function of the on-board network can be improved.

Embodiments of the present disclosure will be described in the following with reference to the drawings. Note that the same reference symbols are given to the same or corresponding elements in the drawings, and description thereof will not be repeated. Furthermore, at least some of the embodiments described in the following may be combined as appropriate.

### First Embodiment

### On-Board Communication System

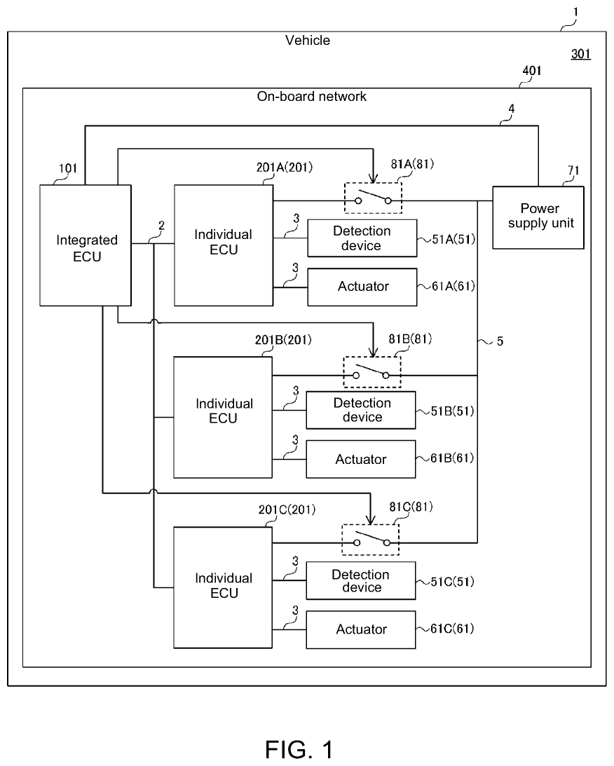

FIG. 1 is a diagram illustrating a configuration of an on-board communication system according to a first embodiment of the present disclosure. Referring to FIG. 1, an on-board communication system 301 includes an integrated electronic control unit (ECU) 101, a plurality of individual ECUs 201, a plurality of detection devices 51, a plurality of actuators 61, a power supply unit 71, and a plurality of relays 81. The integrated ECU 101 is an example of the on-board control apparatus. The individual ECUs 201 are examples of the on-board apparatuses. The detection devices 51 and the actuators 61 are examples of the on-board devices.

In the example illustrated in FIG. 1, the on-board communication system 301 includes individual ECUs 201A, 201B, and 201C that are individual ECUs 201, detection devices 51A, 51B, and 51C that are detection devices 51, actuators 61A, 61B, and 61C that are actuators 61, and relays 81A, 81B, and 81C that are relays 81. The on-board communication system 301 is installed in a vehicle 1.

The integrated ECU 101, the plurality of individual ECUs 201, the plurality of detection devices 51, and the plurality of actuators 61 constitute an on-board network 401.

The integrated ECU 101 is connected to the individual ECU 201A, the individual ECU 201B, and the individual ECU 201C via a cable 2.

The detection devices 51A, 51B, and 51C are respectively connected to the individual ECUs 201A, 201B, and 201C via cables 3. The actuators 61A, 61B, and 61C are respectively connected to the individual ECUs 201A, 201B, and 201C via cables 3.

For example, the cables 2 and 3 are transmission lines conforming to one or more standards such as Controller Area Network (CAN) (registered trademark), CAN with Flexible Data Rate (CAN FD), FlexRay (registered trademark), Media Oriented Systems Transport (MOST) (registered trademark), Ethernet (registered trademark), and Local Interconnect Network (LIN).

The detection devices 51 detect information relating to the vehicle 1. For example, the detection devices 51 are various sensors. For example, the detection devices 51 perform measurement periodically and transmit detection data indicating measurement results to the individual ECUs 201.

The individual ECUs 201 each transmit, to the integrated ECU 101, detection data received from the detection device 51 connected thereto.

The integrated ECU 101 is used in the on-board network 401, which includes the plurality of individual ECUs 201. For example, the integrated ECU 101 operates on power supplied from an ignition power supply of the vehicle 1. For example, based on detection data received from an individual ECU 201, the integrated ECU 101 generates control information for driving one or more actuators 61, and transmits the generated control information to the individual ECU 201 or one or more individual ECUs 201 different from the individual ECU 201.

The individual ECUs 201 each drive the actuator 61 connected thereto based on control information received from the integrated ECU 101.

For example, the actuators 61 are devices corresponding to an air-conditioning function in seats of the vehicle 1, devices corresponding to an air-freshener-spraying function in the seats of the vehicle 1, devices corresponding to a massage function in the seats of the vehicle 1, and devices corresponding to a door opening/closing function of the vehicle 1.

The integrated ECU 101 and the individual ECUs 201 provide various services in the on-board network 401 by communicating with one another to drive the actuators 61, as described above.

The power supply unit 71 supplies power in the vehicle 1. For example, the power supply unit 71 includes the ignition power supply, an accessory power supply, a battery, and the like.

The power supply unit 71 is connected to the integrated ECU 101 via a power cable 4. The power supply unit 71 supplies power to the integrated ECU 101 via the power cable 4.

The power supply unit 71 is connected to each individual ECU 201 via a power cable 5. The power supply unit 71 supplies power to each individual ECU 201 via a power cable 5.

The relay 81A is connected between the individual ECU 201A and the power supply unit 71. The relay 81B is connected between the individual ECU 201B and the power supply unit 71. The relay 81C is connected between the individual ECU 201C and the power supply unit 71.

The relays 81 switch on and off in accordance with control by a later-described controlling unit 32 in the integrated ECU 101. For example, the relays 81 are off in an initial state in which the ignition power supply of the vehicle 1 has transitioned from off to on.

Note that the on-board communication system 301 may be configured to include two individual ECUs 201 or four or more individual ECUs 201. Furthermore, the on-board communication system 301 may be configured to include two or more integrated ECUs 101. Furthermore, two or more detection devices 51 may be connected to each individual ECU 201. Furthermore, two or more actuators 61 may be connected to each individual ECU 201.

### Integrated ECU

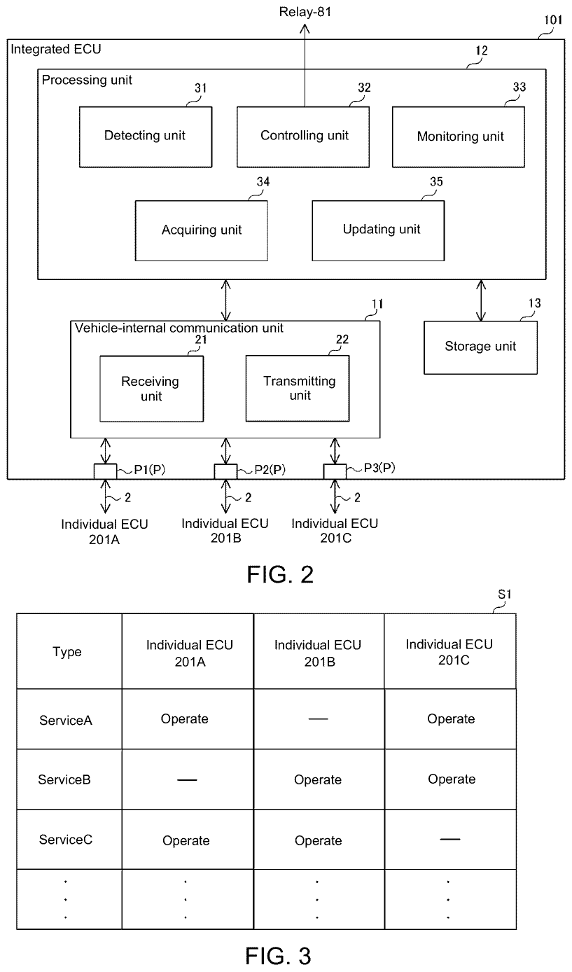

FIG. 2 is a diagram illustrating a configuration of the integrated ECU according to the first embodiment of the present disclosure. Referring to FIG. 2, the integrated ECU 101 includes a plurality of communication ports P, a vehicle-internal communication unit 11, a processing unit 12, and a storage unit 13. The vehicle-internal communication unit 11 includes a receiving unit 21 and a transmitting unit 22. The processing unit 12 includes a detecting unit 31, a controlling unit 32, a monitoring unit 33, an acquiring unit 34, and an updating unit 35. For example, one or both of the vehicle-internal communication unit 11 and the processing unit 12 is/are implemented by means of processing circuitry including one or more processors. For example, the storage unit 13 is a non-volatile memory included in the above-described processing circuitry.

The communication ports P are terminals to which the cables 2 can be connected. The communication ports P are connected to the corresponding individual ECUs 201 via the cables 2.

Specifically, the integrated ECU 101 includes the three communication ports P1, P2, and P3 as the plurality of communication ports P. The individual ECU 201A, the individual ECU 201B, and the individual ECU 201C are respectively connected to the communication port P1, the communication port P2, and the communication port P3 via the cables 2.

### Detecting Unit

The detecting unit 31 executes a detection process for detecting the type of service to be executed in the on-board network 401.

Specifically, for example, a user of the vehicle 1 performs, on an unillustrated navigation apparatus provided in the vehicle 1, an operation that is an instruction to start a desired service.

Upon receiving the operation from the user, the navigation apparatus acquires, based on the details of the received operation, service start information that indicates that a service is to be started and indicates the type of service. The navigation apparatus transmits the acquired service start information to the integrated ECU 101.

The receiving unit 21 in the integrated ECU 101 outputs, to the detecting unit 31, the service start information received from the navigation apparatus.

The detecting unit 31 executes the detection process upon receiving the service start information from the receiving unit 21. Specifically, the detecting unit 31 detects, as the type of service to be executed in the on-board network 401, the type of service indicated by the service start information received from the receiving unit 21. The detecting unit 31 outputs, to the controlling unit 32 and the acquiring unit 34, detection information indicating the detection result.

Note that the detecting unit 31 may detect the type of service to be executed in the on-board network 401 if the state of the vehicle 1 satisfies a predetermined service start condition. For example, the detecting unit 31 may detect a theft prevention service as the type of service to be executed in the on-board network 401 if the vehicle 1 is parked.

### Controlling Unit

The controlling unit 32 controls the operation of a plurality of predetermined individual ECUs 201 (hereinafter also referred to as a “plurality of service-associated apparatuses”) that correspond to the type of service detected by the detecting unit 31.

For example, the controlling unit 32 performs control for activating a plurality of service-associated apparatuses corresponding to the type of service, i.e., control for causing the plurality of service-associated apparatuses to start operating, once a type of service is detected by the detecting unit 31.

Specifically, upon receiving detection information from the detecting unit 31, the controlling unit 32 performs operation start control for switching, from off to on, a plurality of relays 81 respectively connected to a plurality of service-associated apparatuses corresponding to the type of service indicated by the detection information. Thus, the plurality of service-associated apparatuses start operating by receiving power supply from the power supply unit 71.

FIG. 3 is a diagram illustrating an example of management information stored in an on-board control apparatus according to the first embodiment of the present disclosure.

Referring to FIG. 3, the storage unit 13 stores management information S1 that indicates, for each service, a plurality of service-associated apparatuses to be in operation during execution of the service.

In the management information S1, the individual ECU 201A and the individual ECU 201C are the service-associated apparatuses to be in operation during execution of service A. The individual ECU 201B and the individual ECU 201C are the service-associated apparatuses to be in operation during execution of service B. The individual ECU 201A and the individual ECU 201B are the service-associated apparatuses to be in operation during execution of service C.

For example, the management information S1 is registered to the storage unit 13 by the manufacturer of the vehicle 1 upon shipment of the vehicle 1.

Upon receiving detection information from the detecting unit 31, the controlling unit 32 specifies a plurality of service-associated apparatuses by referring to the management information S1 in the storage unit 13. The controlling unit 32 performs operation start control with respect to the relays 81 respectively connected to the specified service-associated apparatuses.

### Monitoring Unit

Referring to FIG. 2 again, the monitoring unit 33 executes a monitoring process for monitoring the operation of the plurality of service-associated apparatuses. Specifically upon receiving detection data from each service-associated apparatus, the receiving unit 21 outputs, to the monitoring unit 33, a receive notification that indicates that the detection data has been received and indicates a port number of the communication port P that has received the detection data.

For example, the monitoring unit 33 calculates, for each service-associated apparatus, the detection-data communication volume (hereinafter also referred to as a “data communication volume”) per a unit of time. Specifically, the monitoring unit 33 counts the number of times the receive notification has been received from the receiving unit 21 per a predetermined unit of time. This count value corresponds to the data communication volume by the service-associated apparatus connected to the communication port P having the port number indicated by the receive notification.

Furthermore, the monitoring unit 33 communicates, to the acquiring unit 34, a monitoring result indicating the port number indicated by the receive notification received from the receiving unit 21 and the calculated data communication volume.

### Acquiring Unit

The acquiring unit 34 acquires service information S2, which indicates, for an individual service, one or more service-associated apparatuses to be in operation during execution of the service and one or more service-associated apparatuses operation of which is to be stopped during execution of the service.

Specifically, the acquiring unit 34 creates or updates service information S2 based on a detection result by the detecting unit 31 and monitoring results by the monitoring unit 33.

Specifically, the acquiring unit 34 determines that the type of service indicated by detection information received from the detecting unit 31 is the type of service that is currently being executed in the on-board network 401. That is, using the detection information received from the detecting unit 31, the acquiring unit 34 ascertains the service that is currently being executed in the on-board network 401.

If the data communication volume indicated by a monitoring result received from the monitoring unit 33 is more than or equal to a threshold, the acquiring unit 34 determines that the service-associated apparatus connected to the communication port P having the port number indicated by the monitoring result is a service-associated apparatus to be kept in operation in the currently executed service.

On the other hand, if the data communication volume indicated by a monitoring result received from the monitoring unit 33 is less than the threshold, the acquiring unit 34 determines that the service-associated apparatus connected to the communication port P having the port number indicated by the monitoring result is a service-associated apparatus operation of which is to be stopped in the currently executed service.

Furthermore, the acquiring unit 34 creates service information S2 based on the determination results. Specifically the acquiring unit 34 creates service information S2 upon determining that the operation of a service-associated apparatus is to be stopped in the currently executed service. The acquiring unit 34 stores the created service information S2 in the storage unit 13.

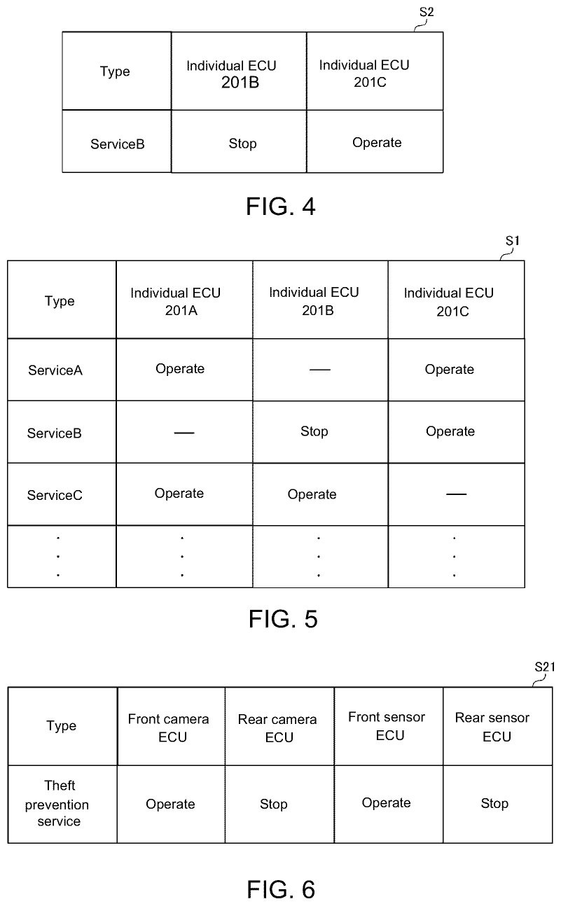

FIG. 4 is a diagram illustrating an example of service information created by the integrated ECU according to the first embodiment of the present disclosure. FIG. 4 illustrates service information S2 created during execution of “service B” illustrated in FIG. 3.

Referring to FIG. 4, in the service information S2, the individual ECU 201C is a service-associated apparatus to be kept in operation in currently executed service B, and the individual ECU 201B is a service-associated apparatus operation of which is to be stopped in currently executed service B.

Furthermore, the acquiring unit 34 updates the service information S2 based on determination results. Specifically the acquiring unit 34 updates the service information S2 upon determining that the operation state of a service-associated apparatus has changed.

Upon acquiring the service information S2, or in other words, upon creating or updating the service information S2, the acquiring unit 34 outputs acquisition information to the transmitting unit 22.

### Updating of Management Information

Referring to FIG. 2 again, upon receiving acquisition information from the acquiring unit 34, the transmitting unit 22 transmits the acquisition information to the navigation apparatus.

Upon receiving the acquisition information from the integrated ECU 101, the navigation apparatus displays a message indicating that service information S2 has been created or updated on a screen based on the received acquisition information.

When a message indicating that service information S2 has been created is displayed on the screen of the navigation apparatus, the user determines whether or not to approve updating of the management information S1 stored in the integrated ECU 101. Furthermore, the user performs an operation of inputting the determination result to the navigation apparatus. The navigation apparatus receives the operation by the user, and transmits, to the integrated ECU 101, determination result information indicating the details of the received operation.

The receiving unit 21 in the integrated ECU 101 outputs, to the updating unit 35, the determination result information received from the navigation apparatus.

If the determination result information received from the receiving unit 21 indicates approval to update the management information S1, the updating unit 35 executes an update process for updating the management information S1.

Specifically, if the determination result information received from the receiving unit 21 indicates approval to update the management information S1, the updating unit 35 updates the management information S1 by retrieving service information S2 stored in the storage unit 13 and registering the retrieved service information S2 to the management information S1.

FIG. 5 is a diagram illustrating an example of the management information after the update process by the integrated ECU according to the first embodiment of the present disclosure.

Referring to FIG. 5, in the management information S1 after the update process, the individual ECU 201B has been changed from being a service-associated apparatus to be in operation during execution of service B to being a service-associated apparatus operation of which is to be stopped during execution of service B. The individual ECU 201C remains to be a service-associated apparatus to be in operation during execution of service B.

Upon completing the update process, the updating unit 35 outputs, to the controlling unit 32, an update completion notification indicating that the update process is complete. On the other hand, if the determination result information received from the receiving unit 21 indicates disapproval of updating of the management information S1, the updating unit 35 does not execute the update process.

### Stop Control

Referring to FIG. 2 again, upon receiving an update completion notification from the updating unit 35, the controlling unit 32 performs operation change control for changing the operation of a subset of the plurality of service-associated apparatuses corresponding to the currently executed service.

Specifically, in a state in which the plurality of service-associated apparatuses are in operation, the controlling unit 32 selects a subset of the plurality of service-associated apparatuses and performs stop control for stopping the operation of the selected service-associated apparatuses.

Specifically, upon receiving an update completion notification from the updating unit 35, the controlling unit 32 selects one or more service-associated apparatuses to be subjected to the stop control based on the service information S2 acquired by the acquiring unit 34, or in other words, by referring to the service information S2 stored in the storage unit 13.

For example, upon selecting the individual ECU 201B as a service-associated apparatus to be subjected to the stop control, the controlling unit 32 performs control for switching, from on to off, the relay 81B connected to the individual ECU 201B. Thus, the individual ECU 201B stops operating due to the supply of power from the power supply unit 71 being stopped. Note that, as the stop control, the controlling unit 32 may transmit, to the one or more selected individual ECUs 201, information requesting to stop the transmission of detection data.

### Activation Control

The controlling unit 32 performs activation control for changing a service-associated apparatuses subjected to the stop control to a service-associated apparatus to be in operation during execution of the service. That is, the activation control is control for disabling the stop control that is being performed on a service-associated apparatus subjected to stop control.

Specifically, upon receiving an update completion notification from the updating unit 35, the controlling unit 32, by referring to the service information S2 stored in the storage unit 13, specifies a service-associated apparatus the operation state of which during execution of the service is to be changed from the stopped state to the operating state.

Furthermore, the controlling unit 32 performs control for switching, from off to on, the relay 81 connected to the specified service-associated apparatus. Thus, the service-associated apparatuses start operating by receiving power supply from the power supply unit 71.

### Termination of Service

The user performs, on the navigation apparatus, an operation that is an instruction to terminate the currently executed service.

Upon receiving the operation from the user, the navigation apparatus acquires, based on the details of the operation received, service termination information that indicates that a service is to be terminated and indicates the type of service. The navigation apparatus transmits the acquired service termination information to the integrated ECU 101.

The receiving unit 21 in the integrated ECU 101 outputs, to the controlling unit 32, the service termination information received from the navigation apparatus.

Upon receiving the service termination information from the receiving unit 21, the controlling unit 32 performs operation termination control for switching, from on to off, the relays 81 connected to the plurality of service-associated apparatuses corresponding to the type of service indicated by the service termination information. Thus, the plurality of service-associated apparatuses stop operating due to the supply of power from the power supply unit 71 being stopped.

### OTHER EXAMPLES OF MONITORING PROCESS

### Example 1

For example, the monitoring unit 33 in the integrated ECU 101 may execute the monitoring process based on whether or not a status-monitoring frame is received from each individual ECU 201. In this case, the operation state of a service-associated apparatus being subjected to the monitoring process would be the transmission state of the frame by the monitored service-associated apparatus.

Specifically, in the on-board communication system 301, there are cases in which the individual ECUs 201 transition from a wake-up mode to a sleep mode, or from the sleep mode to the wake-up mode. Each individual ECU 201 communicates with other apparatuses in the on-board communication system 301 when in the wake-up mode, and stops communicating with other apparatuses in the on-board communication system 301 when in the sleep mode. The sleep mode is a mode in which power consumption is lower than that in the wake-up mode due to, inter alia, some functions of the individual ECU 201 being stopped, power supply to the individual ECU 201 being stopped, or a decrease in the clock frequency in the individual ECU 201.

For example, in the wake-up mode, each individual ECU 201 transmits, to apparatuses in the on-board communication system 301, a frame (hereinafter also referred to as a “network management (NM) frame”) having stored therein an NM message conforming to the AUTomotive Open System ARchitecture (AUTOSAR) (registered trademark). Specifically in the wake-up mode, each individual ECU 201 broadcasts the NM frame to the apparatuses so that status can be monitored, for example.

Upon receiving an NM frame from an individual ECU 201, the receiving unit 21 in the integrated ECU 101 outputs, to the monitoring unit 33, a receive notification that indicates that the NM frame has been received and indicates a port number of the communication port P that has received the NM frame.

Upon receiving the receive notification from the receiving unit 21, the monitoring unit 33 communicates, to the acquiring unit 34, a monitoring result indicating that an NM frame has been received from the individual ECU 201 connected to the communication port P having the port number indicated by the receive notification.

On the other hand, each individual ECU 201 stops transmitting the NM frame if the operation mode thereof transitions from the wake-up mode to the sleep mode.

In a case in which, even after a predetermined amount of time has elapsed since a receive notification was received from the receiving unit 21, a new receive notification indicating that an NM frame has been received from the individual ECU 201 connected to the communication port P having the port number indicated by the receive notification does not arrive, the monitoring unit 33 communicates, to the acquiring unit 34, a monitoring result indicating that an NM frame has not arrived from the individual ECU 201.

Upon receiving, from the receiving unit 21, a monitoring result indicating that an NM frame has been received, the acquiring unit 34 determines that the individual ECU 201 indicated by the monitoring result is a service-associated apparatus to be kept in operation during execution of the service.

On the other hand, upon receiving, from the receiving unit 21, a monitoring result indicating that an NM frame has not arrived, the acquiring unit 34 determines that the individual ECU 201 indicated by the monitoring result is a service-associated apparatus operation of which is to be stopped during execution of the service. In this case, as the stop control, the controlling unit 32 may perform control for causing the operation mode of the individual ECU 201 indicated by the monitoring result to transition from the wake-up mode to the sleep mode.

### Example 2

Alternatively, for example, the monitoring unit 33 may execute the monitoring process based on the operation state of an unillustrated power-supply integrated circuitry (IC) provided in each individual ECU 201. In this case, the operation state of a service-associated apparatus being subjected to the monitoring process would be the power supply state in the monitored service-associated apparatus.

Specifically, a subset of terminals of the power-supply IC in each individual ECU 201 is connected to the integrated ECU 101 via a dedicated line, for example.

The monitoring unit 33 in the integrated ECU 101 detects the switching of the power-supply IC between on and off by monitoring the voltage of the dedicated line.

Specifically, for example, the monitoring unit 33 detects that the power-supply IC has switched on or off by measuring the voltage of the dedicated line. The monitoring unit 33 determines that the power-supply IC is in an on operation state if the measured voltage value is at a logical high level, and determines that the power-supply IC is in an off operation state if the measured voltage value is at a logical low level. The monitoring unit 33 communicates the determination result to the acquiring unit 34.

Upon receiving, from the monitoring unit 33, a determination result indicating that a power-supply IC is in the on operation state, the acquiring unit 34 determines that the individual ECU 201 including the power-supply IC is a service-associated apparatus to be kept in operation during execution of the service.

On the other hand, upon receiving, from the monitoring unit 33, a determination result indicating that a power-supply IC is in the off operation state, the acquiring unit 34 determines that the individual ECU 201 including the power-supply IC is a service-associated apparatus operation of which is to be stopped during execution of the service.

### Example 3

Alternatively, for example, the monitoring unit 33 may execute the monitoring process based on measurement results obtained by a plurality of unillustrated current sensors that are respectively connected to the plurality of individual ECUs 201. In this case, the operation state of a service-associated apparatus being subjected to the monitoring process would be the state of power consumption in the monitored service-associated apparatus.

Specifically, for example, each current sensor periodically measures the current value of a current flowing between the power supply unit 71 and the individual ECU 201 to which the current sensor is connected. The current sensor transmits current data indicating the measurement result to the individual ECU 201 connected thereto.

The individual ECU 201 transmits, to the integrated ECU 101, current data received from the current sensor connected thereto.

The receiving unit 21 in the integrated ECU 101 outputs current data received from each individual ECU 201 to the monitoring unit 33, and communicates, to the monitoring unit 33, the port number of the communication port P that has received the current data.

The monitoring unit 33 determines whether or not the current value indicated by the current data received from the receiving unit 21 is higher than or equal to a predetermined threshold. The monitoring unit 33 communicates, to the acquiring unit 34, a monitoring result indicating the determination result and the port number indicated by the receive notification received from the receiving unit 21.

Upon receiving, from the monitoring unit 33, a notification indicating that a current value is higher than or equal to the threshold, the acquiring unit 34 determines that the individual ECU 201 connected to the communication port P having the port number indicated by the monitoring result received from the monitoring unit 33 is a service-associated apparatus to be kept in operation during execution of the service.

On the other hand, upon receiving, from the monitoring unit 33, a notification indicating that a current value is lower than the threshold, the acquiring unit 34 determines that the individual ECU 201 connected to the communication port P having the port number indicated by the monitoring result received from the monitoring unit 33 is a service-associated apparatus operation of which is to be stop during execution of the service.

### Specific Examples of Service Information

FIGS. 6 to 8 are diagrams illustrating specific examples of service information created by the integrated ECU according to the first embodiment of the present disclosure.

### Theft Prevention Service

FIG. 6 is a diagram illustrating an example of service information S21 created during execution of a theft prevention service in the on-board network 401. The theft prevention service is a service that is executed in the on-board network 401 when the vehicle 1 is parked or the like.

Referring to FIGS. 1 and 6, in the on-board network 401, in which the theft prevention service is provided, a front camera and a rear camera that respectively capture images of the front and rear of the vehicle 1, and a front sensor and a rear sensor that respectively measure a physical quantity in front of and behind the vehicle 1 are provided as the plurality of detection devices 51, for example.

The plurality of service-associated apparatuses corresponding to the theft prevention service include service-associated apparatuses provided in correspondence with the installation positions of on-board devices in the vehicle 1 in which the on-board network 401 is installed. Specifically, the plurality of service-associated apparatuses corresponding to the theft prevention service include a plurality of individual ECUs 201 respectively connected to the front camera, the rear camera, the front sensor, and the rear sensor.

Hereinafter, the individual ECU 201 connected to the front camera and the individual ECU 201 connected to the rear camera are respectively referred to also as a “front camera ECU” and a “rear camera ECU”. Furthermore, the individual ECU 201 connected to the front sensor and the individual ECU 201 connected to the rear sensor are respectively referred to also as a “front sensor ECU” and a “rear sensor ECU”.

In the service information S21, the front camera ECU and the front sensor ECU are service-associated apparatuses to be in operation during execution of the theft prevention service, and the rear camera ECU and the rear sensor ECU are service-associated apparatuses operation of which is to be stopped during execution of the theft prevention service. That is, the acquiring unit 34 in the integrated ECU 101 monitors the operation of the plurality of service-associated apparatuses corresponding to the theft prevention service, and creates service information S21 as illustrated in FIG. 6 upon determining that the rear camera ECU and the rear sensor ECU do not need to be in operation.

### Seat Air-Conditioning Service

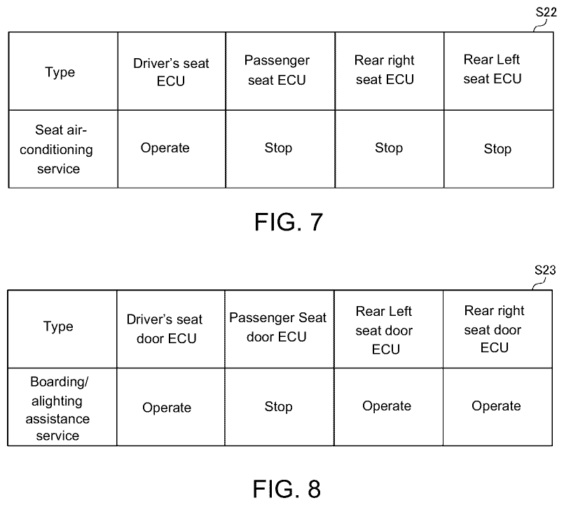

FIG. 7 is a diagram illustrating an example of service information S22 created during execution of a seat air-conditioning service in the on-board network 401. For example, the seat air-conditioning service is a service relating to an air-conditioning function for providing heating and cooling in seats of the vehicle 1.

Referring to FIGS. 1 and 7, the plurality of service-associated apparatuses corresponding to the seat air-conditioning service include service-associated apparatuses provided in correspondence with the seats of the vehicle 1, in which the on-board network 401 is installed. Specifically, the plurality of service-associated apparatuses corresponding to the seat air-conditioning service include an individual ECU 201 corresponding to the air-conditioning function for the driver's seat, an individual ECU 201 corresponding to the air-conditioning function for the passenger seat, an individual ECU 201 corresponding to the air-conditioning function for the rear right seat, and an individual ECU 201 corresponding to the air-conditioning function for the rear left seat.

In the following, the individual ECU 201 corresponding to the air-conditioning function of the driver's seat door and the individual ECU 201 corresponding to the air-conditioning function of the passenger seat door are also respectively referred to as a “driver's seat ECU” and a “passenger seat ECU”. Furthermore, the individual ECU 201 corresponding to the air-conditioning function of the rear right seat door and the individual ECU 201 corresponding to the air-conditioning function of the rear left seat door are also respectively referred to as a “rear right seat ECU” and a “rear left seat ECU”.

In the service information S22, the driver's seat ECU is a service-associated apparatus to be in operation during execution of the seat air-conditioning service, and the passenger seat ECU, the rear right seat ECU, and the rear left seat ECU are service-associated apparatuses operation of which is to be stopped during execution of the seat air-conditioning service. That is, the acquiring unit 34 in the integrated ECU 101 monitors the operation of the plurality of service-associated apparatuses corresponding to the seat air-conditioning service, and creates service information S22 as illustrated in FIG. 7 upon determining that the passenger seat ECU, the rear right seat ECU, and the rear left seat ECU do not need to be in operation.

### Boarding/Alighting Assistance Service

FIG. 8 is a diagram illustrating an example of service information S23 created during execution of a boarding/alighting assistance service in the on-board network 401. For example, the boarding/alighting assistance service is a service relating to the opening/closing function of doors when users board and alight.

Referring to FIGS. 1 and 8, the plurality of service-associated apparatuses corresponding to the boarding/alighting assistance service include service-associated apparatuses provided in correspondence with the doors of the vehicle 1, in which the on-board network 401 is installed. Specifically, the plurality of service-associated apparatuses corresponding to the boarding/alighting assistance service include an individual ECU 201 corresponding to the opening/closing function of the driver's seat door, an individual ECU 201 corresponding to the opening/closing function of the passenger seat door, an individual ECU 201 corresponding to the opening/closing function of the rear right seat door, and an individual ECU 201 corresponding to the opening/closing function of the rear left seat door.

In the following, the individual ECU 201 corresponding to the opening/closing function of the driver's seat door and the individual ECU 201 corresponding to the opening/closing function of the passenger seat door are also respectively referred to as a “driver's seat door ECU” and a “passenger seat door ECU”. Furthermore, the individual ECU 201 corresponding to the opening/closing function of the rear right seat door and the individual ECU 201 corresponding to the opening/closing function of the rear left seat door are also respectively referred to as a “rear right seat door ECU” and a “rear left seat door ECU”.

In the service information S23, the driver's seat door ECU, the rear right seat door ECU, and the rear left seat door ECU are service-associated apparatuses to be in operation during execution of the boarding/alighting assistance service, and the passenger seat door ECU is a service-associated apparatuses operation of which is to be stopped during execution of the boarding/alighting assistance service. That is, the acquiring unit 34 in the integrated ECU 101 monitors the operation of the plurality of service-associated apparatuses corresponding to the boarding/alighting assistance service, and creates service information S23 as illustrated in FIG. 8 upon determining that the passenger seat ECU does not need to be in operation.

### Operation Flow

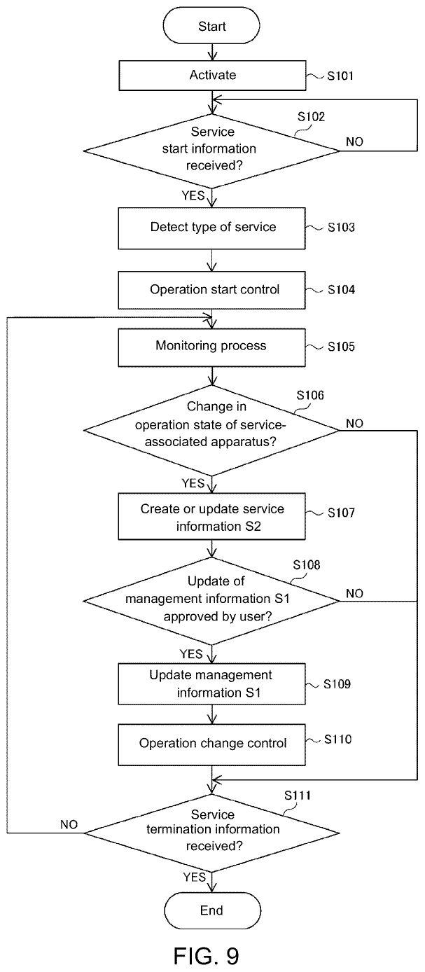

FIG. 9 is a flowchart defining an operation procedure of processes executed when the integrated ECU according to the first embodiment of the present disclosure controls service-associated apparatuses.

Referring to FIG. 9, first, the integrated ECU 101 is activated when the ignition power supply of the vehicle 1 switches from off to on (step S101).

Next, upon receiving service start information from the navigation apparatus receiving a user operation (YES in step S102), the integrated ECU 101 detects the type of service to be executed in the on-board network 401 (step S103).

Next, the integrated ECU 101 performs operation start control with respect to predetermined individual ECUs 201 corresponding to the detected service, i.e., a plurality of service-associated apparatuses. For example, as described above, the integrated ECU 101 performs control for switching, from off to on, the plurality of relays 81 respectively connected to the plurality of service-associated apparatuses (step S104).

Next, the integrated ECU 101 executes a monitoring process for monitoring the operation of the plurality of service-associated apparatuses (step S105).

Next, upon determining that the operation state of a service-associated apparatus among the plurality of service-associated apparatuses has changed (YES in step S106), the integrated ECU 101 creates or updates service information S2 (step S107).

Next, if the user approves updating of the management information S1 (YES in step S108), the integrated ECU 101 updates the management information S1. For example, as described above, upon receiving, from the navigation apparatus, determination result information indicating that the user has approved updating of the management information S1, the integrated ECU 101 updates the management information S1 by registering the updated service information S2 to the management information S1 (step S109).

Next, the integrated ECU 101 performs operation change control based on the updated management information S1 (step S110).

Next, the integrated ECU 101 repeats the processes from step S105 to step S110 until service termination information is received from the navigation apparatus (NO in step S111).

On the other hand, if there is no change in the operation state of any service-associated apparatus (NO in step S106), the integrated ECU 101 does not execute the process for creating or updating the service information S2, the process for updating the management information S1, or the operation change control.

Furthermore, if the user disapproves of the updating of the management information S1 (NO in step S108), the integrated ECU 101 does not execute the process for updating the management information S1 or the operation change control.

Next, the integrated ECU 101 repeats the processes from step S105 to step S110 until service termination information is received from the navigation apparatus (NO in step S111).

Then, the integrated ECU 101 terminates processing upon receiving service termination information from the navigation apparatus (YES in step S111).

Note that, while the on-board communication system 301 according to the first embodiment of the present disclosure is configured such that the integrated ECU 101 includes the detecting unit 31, the controlling unit 32, the monitoring unit 33, and the acquiring unit 34, there is no limitation to this. For example, an on-board apparatus other than the integrated ECU 101 may include the detecting unit 31, the controlling unit 32, the monitoring unit 33, and the acquiring unit 34 and execute the above-described processes.

Furthermore, while the on-board communication system 301 according to the first embodiment of the present disclosure is configured such that the integrated ECU 101 includes the monitoring unit 33, there is no limitation to this. For example, a configuration may be adopted in which the integrated ECU 101 does not include the monitoring unit 33. In this case, the service information S2 may be created in advance for each user instead of being created based on monitoring results relating to the operation of the plurality of service-associated apparatuses. That is, the acquiring unit 34 may acquire service information S2 created in advance for each user.

Furthermore, while the on-board communication system 301 according to the first embodiment of the present disclosure is configured such that the integrated ECU 101 performs operation change control if the user approves the updating of the management information S1, there is no limitation to this. For example, a configuration may be adopted in which the integrated ECU 101 performs operation change control regardless of the presence/absence of user approval regarding the updating of the management information S1.

Furthermore, while the on-board communication system 301 according to the first embodiment of the present disclosure is configured such that the integrated ECU 101 transmits acquisition information indicating that service information S2 has been acquired to the navigation apparatus while a service desired by the user is being provided in the on-board network 401, there is no limitation to this. For example, a configuration may be adopted in which the integrated ECU 101 transmits the acquisition information to the navigation apparatus the next time the desired service is provided. In this case, for example, the integrated ECU 101 transmits the acquisition information to the navigation apparatus upon receiving service start information indicating that the desired service is to be started. Then, upon receiving, from the navigation apparatus, determination result information indicating that the user has approved the updating of the management information S1, the integrated ECU 101 updates the management information S1 and also performs stop control.

Furthermore, while the on-board communication system 301 according to the first embodiment of the present disclosure is configured such that the integrated ECU 101 performs activation control for disabling the stop control that is being performed on a service-associated apparatus subjected to stop control, there is no limitation to this. For example, a configuration may be adopted in which the integrated ECU 101 does not perform activation control.

Furthermore, while the on-board communication system 301 according to the first embodiment of the present disclosure is configured such that the integrated ECU 101 performs activation control after updating the management information S1, there is no limitation to this. For example, the integrated ECU 101 may perform activation control upon receiving, from the user, information indicating that updated management information S1 stored in the storage unit 13 is to be reset to the management information S1 at the time when the vehicle 1 was shipped.

### Second Embodiment

In the above-described first embodiment of the present disclosure, the integrated ECU 101 creates service information S2 based on monitoring results relating to the operation of a plurality of service-associated apparatuses. In contrast to this, in a second embodiment of the present disclosure, a management apparatus 151 in a communication system 501 creates service information S2 based on the monitoring results obtained by the integrated ECU 101. Matters other than those described in the following are the same as those in the on-board communication system 301 according to the first embodiment.

### Communication System

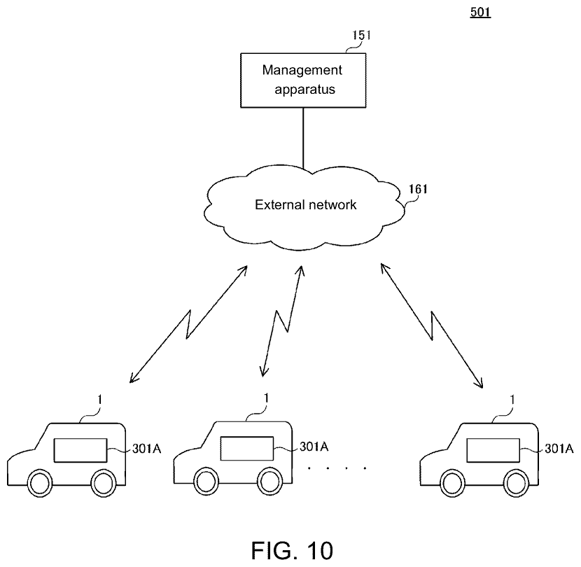

FIG. 10 is a diagram illustrating a configuration of a communication system according to the second embodiment of the present disclosure. Referring to FIG. 10, the communication system 501 includes one or more on-board communication systems 301A and a management apparatus 151. Each on-board communication systems 301A is installed in a vehicle 1. For example, the management apparatus 151 is a server.

### Integrated ECU

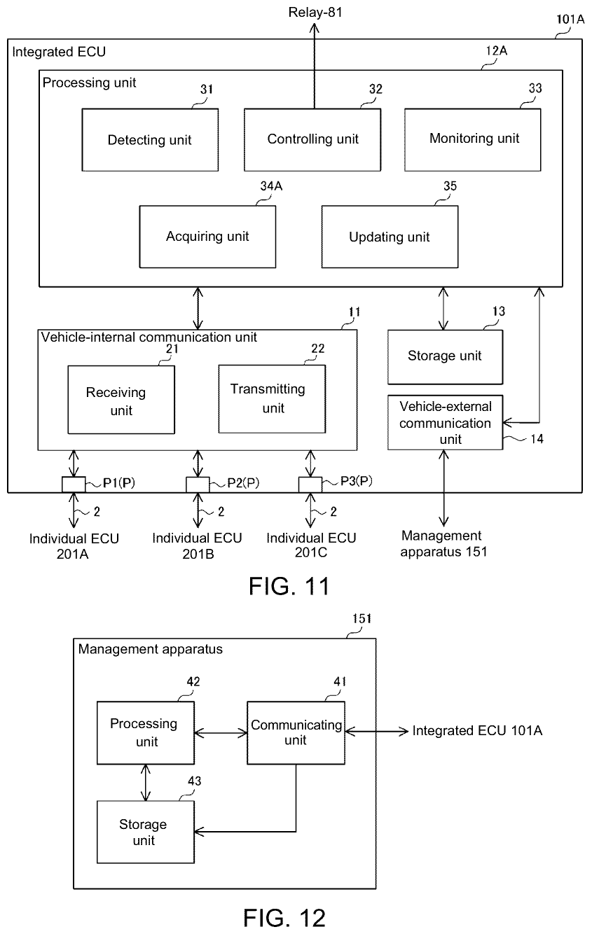

FIG. 11 is a diagram illustrating a configuration of an integrated ECU according to the second embodiment of the present disclosure. Referring to FIGS. 10 and 11, when compared with the on-board communication system 301 according to the first embodiment of the present disclosure, the on-board communication system 301A includes an integrated ECU 101A in place of the integrated ECU 101.

For example, the integrated ECU 101A transmits and receives information to and from the management apparatus 151 via an external network 161 such as the Internet.

Referring to FIG. 11, when compared with the integrated ECU 101 according to the first embodiment of the present disclosure, the integrated ECU 101A further includes a vehicle-external communication unit 14, and includes a processing unit 12A in place of the processing unit 12. When compared with the processing unit 12 illustrated in FIG. 2, the processing unit 12A includes an acquiring unit 34A in place of the acquiring unit 34. For example, some or all of the vehicle-internal communication unit 11, the processing unit 12A, and the vehicle-external communication unit 14 are implemented by means of processing circuitry including one or more processors. For example, the storage unit 13 is a non-volatile memory included in the above-described processing circuitry.

The vehicle-external communication unit 14 communicates with the management apparatus 151 via the external network 161 by performing wireless communication with an unillustrated wireless base station according to a communication method such as WiFi (registered trademark), long-term evolution (LTE) (registered trademark), or 5G. Note that the vehicle-external communication unit 14 is not limited to being configured to communicate with the management apparatus 151 via a wireless base station and the external network 161, and may be configured to communicate with the management apparatus 151 via a wired line. Furthermore, the vehicle-external communication unit 14 may be configured to communicate with the management apparatus 151 with other intermediary on-board apparatuses therebetween.

The detecting unit 31 outputs a detection result to the vehicle-external communication unit 14. Furthermore, the monitoring unit 33 outputs, to the vehicle-external communication unit 14, monitoring results relating to the operation of a plurality of service-associated apparatuses.

The vehicle-external communication unit 14 transmits, to the management apparatus 151, monitoring information indicating the detection result received from the detecting unit 31 and the monitoring results received from the monitoring unit 33. For example, the vehicle-external communication unit 14 periodically transmits monitoring information to the management apparatus 151.

### Management Apparatus

FIG. 12 is a diagram illustrating a configuration of the management apparatus 151 according to the second embodiment of the present disclosure. Referring to FIG. 12, the management apparatus 151 includes a communicating unit 41, a processing unit 42, and a storage unit 43. Some or all of the communicating unit 41 and the processing unit 42 are implemented by means of processing circuitry including one or more processors. For example, the storage unit 43 is a non-volatile memory included in the above-described processing circuit.

Upon receiving the monitoring information from the integrated ECU 101A, the communicating unit 41 outputs, to the processing unit 42, a receive notification that indicates that the monitoring information has been received. Furthermore, the communicating unit 41 stores the received monitoring information in the storage unit 43.

The processing unit 42 creates service information S2 based on the monitoring information received from the integrated ECU 101A.

Specifically, upon receiving the receive notification from the communicating unit 41, the processing unit 42 refers to the monitoring information stored in the storage unit 43 and thereby creates or updates service information S2.

The processing unit 42 outputs, to the communicating unit 41, the service information S2 that has been created or updated. The communicating unit 41 transmits, to the integrated ECU 101A, the service information S2 received from the processing unit 42.

### Updating of Management Information

In the integrated ECU 101A, the receiving unit 21 outputs, to the acquiring unit 34, the service information S2 received from the management apparatus 151. That is, the acquiring unit 34 acquires, from the management apparatus 151, the service information S2 created based on the monitoring results obtained by the monitoring unit 33.

The acquiring unit 34 stores the service information S2 received from the receiving unit 21 in the storage unit 13, and also outputs, to the transmitting unit 22, acquisition information indicating that the service information S2 has been acquired.

### Operation Flow

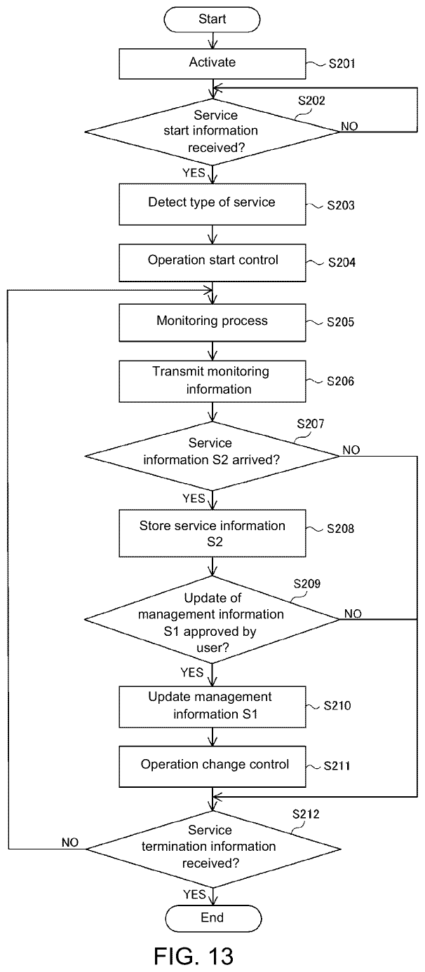

FIG. 13 is a flowchart illustrating an operation procedure of processes by the integrated ECU according to the second embodiment of the present disclosure.

Referring to FIG. 13, the processes from step S201 to step S205 are respectively the same as the processes from step S101 to step S105 illustrated in FIG. 9.

Next, the integrated ECU 101A transmits monitoring information to the management apparatus 151 (step S206).

Next, when service information S2 from the management apparatus 151 arrives (YES in step S207), the integrated ECU 101A stores the service information S2 in the storage unit 13 (step S208).

The processes from step S209 to step S212 are respectively the same as the processes from step S108 to step S111 illustrated in FIG. 9.

On the other hand, if service information S2 from the management apparatus 151 does not arrive (NO in step S207), the integrated ECU 101A does not execute the process for storing service information S2, the process for updating the management information S1, or the operation change control.

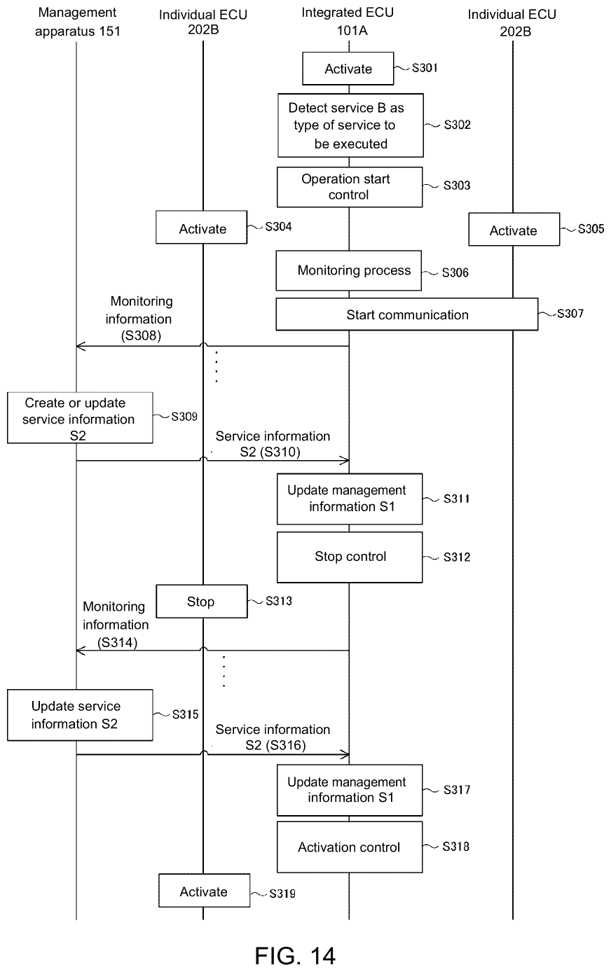

FIG. 14 is a diagram illustrating an example of a sequence of the operation change control in the communication system according to the second embodiment of the present disclosure.

Referring to FIG. 14, first, the integrated ECU 101A is activated when the ignition power supply of the vehicle 1 switches from off to on (step S301).

Next, the integrated ECU 101A detects the type of service to be executed in the on-board network 401. Here, the integrated ECU 101A detects service B as the type of service to be executed in the on-board network 401 (step S302).

Next, the integrated ECU 101A performs control for switching, from off to on, the relay 81B and the relay 81C respectively connected to the individual ECU 201B and the individual ECU 201C corresponding to detected service B (step S303).

Next, the individual ECU 201B and the individual ECU 201C operate during execution of service B (step S304 and step S305).

Next, the integrated ECU 101A executes a monitoring process for monitoring the operation of the individual ECU 201B and the individual ECU 201C (step S306).

Next, the integrated ECU 101A starts communication with the individual ECU 201C (step S307).

Next, the integrated ECU 101A periodically transmits, to the management apparatus 151, monitoring information that indicates a detection result indicating that the type of service to be executed in the on-board network 401 is service B and indicates monitoring results relating to the operation of the individual ECU 201B and the individual ECU 201C (step S308).

Next, the management apparatus 151 receives monitoring information from the integrated ECU 101A, and creates or updates service information S2 based on the monitoring information (step S309).

Next, the management apparatus 151 transmits, to the integrated ECU 101A, the service information S2 that has been created or updated. Here, the service information S2 that has been created or updated indicates that the individual ECU 201B is a service-associated apparatus to be kept in operation in currently executed service B, and the individual ECU 201C is a service-associated apparatus operation of which is to be stopped in currently executed service B (step S310).

Next, the integrated ECU 101A updates the management information S1 by registering the service information S2 received from the management apparatus 151 to the management information S1. For example, as described above, the integrated ECU 101A updates the management information S1 upon receiving, from the user, determination result information indicating approval to update the management information S1 (step S311).

Next, based on the service information S2 received from the management apparatus 151, the integrated ECU 101A performs stop control for stopping the operation of the individual ECU 201B. For example, as described above, the integrated ECU 101A performs control for switching, from on to off, the relay 81B connected to the individual ECU 201B (step S312).

Next, the individual ECU 201B stops operating due to the supply of power from the power supply unit 71 being stopped (step S313).

Next, the integrated ECU 101A periodically transmits, to the management apparatus 151, monitoring information that indicates a detection result indicating that the type of service being executed in the on-board network 401 is service B and indicates monitoring results relating to the operation of the individual ECU 201B and the individual ECU 201C (step S314).

Next, the management apparatus 151 receives monitoring information from the integrated ECU 101A, and updates the service information S2 based on the monitoring information. Here, the updated service information S2 indicates that the individual ECU 201B and the individual ECU 201C are service-associated apparatuses to be kept in operation in currently executed service B (step S315).

Next, the management apparatus 151 transmits the updated service information S2 to the integrated ECU 101A (step S316).

Next, the integrated ECU 101A updates the management information S1 by registering the service information S2 received from the management apparatus 151 to the management information S1. Here, in the management information S1, the integrated ECU 101A changes the individual ECU 201B from being a service-associated apparatus operation of which is to be stopped to being a service-associated apparatus to be in operation in currently executed service B (step S317).

Next, based on the service information S2 received from the management apparatus 151, the integrated ECU 101A performs activation control for changing the individual ECU 201B subjected to the stop control to a service-associated apparatus to be in operation in currently executed service B. For example, as described above, the integrated ECU 101A performs control for switching, from off to on, the relay 81B connected to the individual ECU 201B (step S318).

Next, the individual ECU 201B is activated by power being supplied from the power supply unit 71 (step S319).

Note that some or all of the functions of the management apparatus 151 according to the second embodiment of the present disclosure may be provided by cloud computing. That is, the management apparatus 151 according to the second embodiment of the present disclosure may be a cloud server that is formed by a plurality of servers.

The other configurations and operations are similar to those in the on-board communication system 301 according to the first embodiment, and detailed description thereof is not repeated.

The above-described embodiments shall be construed as being illustrative and non-restrictive in all regards. The scope of the present disclosure is defined by the claims rather than the above description, and is intended to include all modifications within the meaning and scope of equivalents of the claims.

Each process (function) in the above-described embodiments is realized by processing circuitry including one or more processors. The processing circuitry may be formed from an integrated circuit or the like in which one or more memories, various analog circuits, and various digital circuits are combined in addition to the one or more processors. The one or more memories have stored therein one or more program (instructions) that cause the one or more processors to execute the above-described processes. The one or more processors may execute the processes in accordance with the programs retrieved from the one or more memories, or may execute the processes in accordance with a logic circuit designed in advance to execute the processes. The processors may be any of various processors that are suitable for controlling a computer, such as a central processing unit (CPU), a graphics processing unit (GPU), a digital signal processor (DSP), a field-programmable gate array (FPGA), and an application-specific integrated circuit (ASIC). Note that the physically discrete processors may cooperate with one another to execute the processes. For example, the processors mounted on a plurality of physically discrete computers may cooperate with one another via a network such as a local area network (LAN), a wide area network (WAN), or the Internet to execute the processes. The programs may be installed to the memories from an external server apparatus or the like via the network, or may be distributed in a state in which the programs are stored in a recording medium such as a compact disc read-only memory (CD-ROM), a digital versatile disc read-only memory (DVD-ROM), or a semiconductor memory and be installed to the memories from the recording medium.

The above description includes the features in the supplementary notes below.

### Supplementary Note 1

An on-board control apparatus for use in an on-board network including a plurality of on-board apparatuses, the on-board control apparatus including
processing circuitry,
wherein the processing circuitry:
   detects a type of service to be executed in the on-board network; and
   a controlling unit that, in a state in which a plurality of service-associated apparatuses, which are predetermined ones of the on-board apparatuses that correspond to the detected type of service, are in operation, selects a subset of the service-associated apparatuses and performs stop control for stopping the operation of the selected service-associated apparatuses.

### Supplementary Note 2

An operation control program for use in an on-board control apparatus that is for use in an on-board network including a plurality of on-board apparatuses, the on-board control program causing a computer to function as:
a detecting unit that detects a type of service to be executed in the on-board network; and
a controlling unit that, in a state in which a plurality of service-associated apparatuses, which are predetermined ones of the on-board apparatuses that correspond to the type of service detected by the detecting unit, are in operation, selects a subset of the service-associated apparatuses and performs stop control for stopping the operation of the selected service-associated apparatuses.

1. An on-board control apparatus for use in an on-board network including a plurality of on-board apparatuses, the on-board control apparatus comprising:
a detecting unit that detects a type of service to be executed in the on-board network; and
a controlling unit that, in a state in which a plurality of service-associated apparatuses, which are predetermined ones of the on-board apparatuses that correspond to the type of service detected by the detecting unit, are in operation, selects a subset of the service-associated apparatuses and performs stop control for stopping the operation of the selected service-associated apparatuses.

2. The on-board control apparatus according to claim 1 further including,
an acquiring unit that acquires service information that indicates, for the individual service, one or more of the service-associated apparatuses to be in operation during execution of the service and one or more of the service-associated apparatuses operation of which is to be stopped during execution of the service,
wherein the controlling unit selects the service-associated apparatuses to be subjected to the stop control based on the service information acquired by the acquiring unit.

3. The on-board control apparatus according to claim 2,
wherein the controlling unit performs control for activating the plurality of service-associated apparatuses corresponding to the type of service once the type of service is detected by the detecting unit,
the on-board control apparatus further comprises
a monitoring unit that monitors the operation of the plurality of service-associated apparatuses, and
the acquiring unit acquires the service information created based on a monitoring result obtained by the monitoring unit.

4. The on-board control apparatus according to claim 1, wherein the plurality of service-associated apparatuses include ones of the service-associated apparatuses provided in correspondence with seats in a vehicle in which the on-board network is installed.

5. The on-board control apparatus according to claim 1, wherein the plurality of service-associated apparatuses include ones of the service-associated apparatuses provided in correspondence with installation positions of on-board devices in a vehicle in which the on-board network is installed.

6. The on-board control apparatus according to claim 1, wherein the plurality of service-associated apparatuses include ones of the service-associated apparatuses provided in correspondence with doors of a vehicle in which the on-board network is installed.

7. A method for controlling operations in an on-board control apparatus that is for use in an on-board network including a plurality of on-board apparatuses, the operation control method comprising:
a step of detecting a type of service to be executed in the on-board network; and
a step of, in a state in which a plurality of service-associated apparatuses, which are predetermined ones of the on-board apparatuses that correspond to the detected type of service, are in operation, selecting a subset of the service-associated apparatuses and performing stop control for stopping the operation of the selected service-associated apparatuses.

8. A communication system comprising:
an on-board control apparatus; and
a management apparatus,
wherein the on-board control apparatus transmits, to the management apparatus, monitoring information indicating a monitoring result relating to operation of a plurality of service-associated apparatuses, which are predetermined ones of a plurality of on-board apparatuses included in an on-board network that correspond to a type of service executed in the on-board network, and
the management apparatus receives the monitoring information from the on-board control apparatus, and transmits, to the on-board control apparatus, service information indicating one or more of the service-associated apparatuses to be in operation during execution of the service and one or more of the service-associated apparatuses operation of which is to be stopped during execution of the service.

9. The on-board control apparatus according to claim 2, wherein the plurality of service-associated apparatuses include ones of the service-associated apparatuses provided in correspondence with seats in a vehicle in which the on-board network is installed.

10. The on-board control apparatus according to claim 3, wherein the plurality of service-associated apparatuses include ones of the service-associated apparatuses provided in correspondence with seats in a vehicle in which the on-board network is installed.

11. The on-board control apparatus according to claim 2, wherein the plurality of service-associated apparatuses include ones of the service-associated apparatuses provided in correspondence with installation positions of on-board devices in a vehicle in which the on-board network is installed.

12. The on-board control apparatus according to claim 3, wherein the plurality of service-associated apparatuses include ones of the service-associated apparatuses provided in correspondence with installation positions of on-board devices in a vehicle in which the on-board network is installed.

13. The on-board control apparatus according to claim 2, wherein the plurality of service-associated apparatuses include ones of the service-associated apparatuses provided in correspondence with doors of a vehicle in which the on-board network is installed.

14. The on-board control apparatus according to claim 3, wherein the plurality of service-associated apparatuses include ones of the service-associated apparatuses provided in correspondence with doors of a vehicle in which the on-board network is installed.
